(19) United States
(12) Patent Application Publication
(10) Pub. No.: US 2026/0155718 A1
(43) Pub. Date: Jun. 4, 2026

(54) MANUFACTURING METHOD OF A MULTI-POLE MAGNETIC CIRCUIT, MULTI-POLE MAGNETIC CIRCUIT, AND STEPPER MOTOR

(71) Applicant: AAC Microtech (Changzhou) Co., Ltd., Changzhou City (CN)

(72) Inventors: Lubin Mao, Changzhou (CN); Xiujiang Si, Changzhou (CN); Wei Song, Changzhou (CN); Ze Fu, Changzhou (CN); Suntong Zhou, Changzhou (CN)

(21) Appl. No.: 19/036,043

(22) Filed: Jan. 24, 2025

Related U.S. Application Data
(63) Continuation of application No. PCT/CN2024/135516, filed on Nov. 29, 2024.

(51) Int. Cl. H02K 15/035; H02K 37/14

(52) U.S. Cl. CPC H02K 15/035; H02K 37/14

(57) ABSTRACT

Provided is a manufacturing method of a multi-pole magnetic circuit, a multi-pole magnetic circuit, and a stepper motor. The method includes: providing first magnets each having a sector-shaped cross-section; assembling the first magnets to obtain a first cylindrical body; and grinding a side surface of the first cylindrical body to obtain a second cylindrical body, and electroplating an outer surface of the second cylindrical body to form a coating, to obtain the multi-pole magnetic circuit for a stepper motor. In the manufacturing method, by preparing the first magnets having larger dimension, assembling the first magnets to obtain the first cylindrical body having larger outer diameter, and grinding the side surface of the first cylindrical body to obtain the second cylindrical body having smaller outer diameter, difficulty of the assembly operation is reduced, roundness and concentricity as well as reliability of the magnetic circuit are improved.

### TECHNICAL FIELD

The present disclosure relates to the field of motor technologies, and in particular to, a manufacturing method of a multi-pole magnetic circuit, a multi-pole magnetic circuit, and a stepper motor.

### BACKGROUND

A motor is an electromagnetic device that realizes the conversion or transmission of electrical energy. The manufacturing process of a stepper motor in the related art includes a procedure of assembling a plurality of magnets to obtain a multi-pole magnetic circuit. However, due to the small size of the magnetic circuit of the stepper motor, the size of the magnets used for assembling is even smaller, the processing into shape and assembling are more difficult, and the roundness and concentricity of the magnetic circuit of the motor obtained after assembling are poor.

Therefore, it is necessary to provide a manufacturing method of a multi-pole magnetic circuit, a multi-pole magnetic circuit, and a stepper motor.

### SUMMARY

Objectives of the present disclosure is to provide a manufacturing method of a multi-pole magnetic circuit, a multi-pole magnetic circuit, and a stepper motor. The multi-pole magnetic circuit is used for manufacturing the stepper motor. The multi-pole magnetic circuit has better roundness and concentricity.

In a first aspect, the present disclosure provides a manufacturing method of a multi-pole magnetic circuit for a stepper motor, including: S1, providing a plurality of first magnets, where each of the first magnets has a sector-ring-shaped cross-section ; S2, assembling the plurality of first magnets to obtain a first cylindrical body; and S3, grinding a side surface of the first cylindrical body by a grinding process to obtain a second cylindrical body, and then electroplating an outer surface of the second cylindrical body to form a coating, so as to obtain the multi-pole magnetic circuit for the stepper motor.

As an improvement, the first magnets are shaped by the grinding process to form second magnets, the second magnets are arranged around a central axis of the multi-pole magnetic circuit, two adjacent second magnets are magnetically opposite to each other at respective ends close to the central axis of the multi-pole magnetic circuit, and the two adjacent second magnets are magnetically opposite to each other at other respective ends.

As an improvement, in the step S3, the grinding process includes one or more of longitudinal grinding, plunge grinding, step grinding, or deep grinding.

As an improvement, in the step S3, the coating is a Ni metal coating formed by metal Ni electroplating, or a composite metal coating formed from Zn and Ni.

As an improvement, the first magnets are sintered magnets, and two adjacent first magnets are bonded and fixed to each other by a bonding layer.

As an improvement, the step S2 further includes providing a rotary shaft; and the step S2 specifically including: providing a rotary shaft, arranging the plurality of first magnets circumferentially around the rotary shaft to obtain the first cylindrical body provided with the rotary shaft.

In a second aspect, the present disclosure provides a multi-pole magnetic circuit manufactured by the manufacturing method as described above.

In a third aspect, the present disclosure provides a stepper motor including the multi-pole magnetic circuit as described above.

The beneficial effects of the present disclosure are that in the manufacturing method of a multi-pole magnetic circuit according to the present disclosure, by first preaparing the plurality of first magnets having a larger dimension, then assembling the first magnets to obtain the first cylindrical body having a larger outer diameter dimension, and then grinding the side surface of the first cylindrical body by the grinding process to obtain the second cylindrical body having a smaller outer diameter dimension, the difficulty of the assembly operation is reduced, the roundness and concentricity of the multi-pole magnetic circuit are improved, and the precise control of the outer diameter tolerance of the magnetic circuit and the reliability of the magnetic circuit are guaranteed.

### BRIEF DESCRIPTION OF DRAWINGS

FIG. 1 is a process flow diagram of a manufacturing method of a multi-pole magnetic circuit of the present disclosure.

FIG. 2 is a structural schematic diagram of a multi-stage magnetic circuit of the present disclosure.

FIG. 3 is a schematic diagram of a magnetic distribution of second magnets in a multi-pole magnetic circuit.

FIG. 4 is a structural schematic diagram of a stepper motor of the present disclosure.

FIG. 5 is a top view of a stepper motor of the present disclosure.

FIG. 6 is a sectional view along A-A of FIG. 5.

FIG. 7 is an assembly schematic diagram of claw-poles.

FIG. 8 is a structural schematic diagram of a claw-pole.

FIG. 9 is another process flow diagram of the manufacturing method of a multi-pole magnetic circuit of the present disclosure.

### DESCRIPTION OF EXAMPLES

The present disclosure is further illustrated below in conjunction with the accompanying drawings and implementations. The implementations described below by reference to the accompanying drawings are exemplary and are intended solely to explain the present disclosure and are not to be construed as a limitation of the present disclosure.

In order to enable those in the art to better understand the solutions of the present disclosure, the technical solutions in the embodiments of the present disclosure will be clearly and completely described below in conjunction with the accompanying drawings in the embodiments of the present disclosure. Apparently, the described embodiments are only a part of the embodiments of the present disclosure and not all of the embodiments.

In the description of the present disclosure, the terms “first”, “second”, “third”, “fourth”, etc., are only used for the purpose of distinguishing the description, and cannot be understood as indicating or implying relative importance, nor as indicating or implying order.

It is to be noted that in the present disclosure, an outward direction refers to a direction away from a central axis of a multi-pole magnetic circuit, and an inward direction refers to a direction towards the central axis of the multi-pole magnetic circuit.

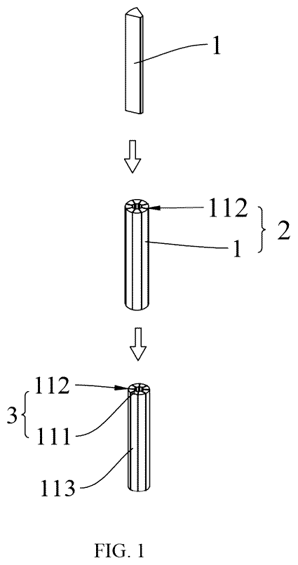

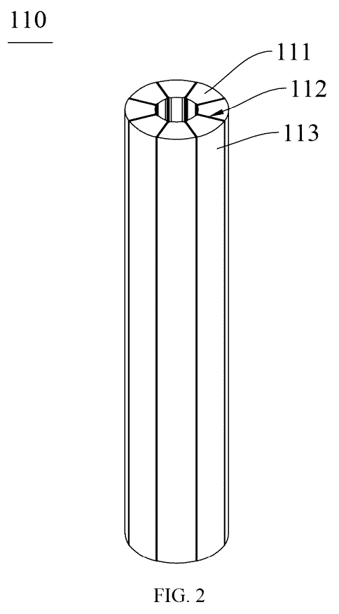

Embodiment 1: in a first aspect, the present disclosure provides a manufacturing method of a multi-pole magnetic circuit, where the multi-pole magnetic circuit 110 is used for preparing a stepper motor. As shown in FIGS. 1 and 2, the method includes: S1, providing a plurality of first magnets 1, where each of the first magnets 1 has a sector-ring-shaped cross-section; S2, assembling the plurality of first magnets 1 to obtain a first cylindrical body 2; and S3, grinding a side surface of the first cylindrical body 2 by a grinding process to obtain a second cylindrical body 3, and then electroplating an outer surface of the second cylindrical body 3 to form a coating 113, so as to obtain the multi-pole magnetic circuit 110 for the stepper motor.

The manufacturing method of a multi-pole magnetic circuit 110 as described in the present disclosure is suitable for manufacturing the stepper motor. First, the plurality of first magnets 1 having a larger dimension are prepared, then the obtained first magnets 1 are spliced and assembled to obtain the first cylindrical body 2 having a larger outer diameter dimension, and then the side surface of the obtained first cylindrical body 2 is ground by the grinding process to obtain the second cylindrical body 3 having a smaller outer diameter dimension. The first magnets 1 having a larger dimension are not only convenient to process, but also have a lower difficulty in assembling, which guarantees the roundness and concentricity of the spliced first cylindrical body 2, and provides a basis for manufacturing the multi-polar magnetic circuit 110 with better roundness and concentricity. Then, the outer diameter of the first cylindrical body 2 with a large dimension is grinded into the required second cylindrical body 3 with a smaller outer diameter dimension by the grinding process, and in this way, the outer diameter tolerance of the magnetic circuit is accurately controlled. And the grinded second cylindrical body 3 is electroplated, which guarantees the reliability of the magnetic circuit. In addition, in the step S2, the second cylinder bodies 3 with different outer diameters can be manufactured by controlling a deformation amount of the outer diameter in the grinding process according to actual requirements, to meet the assembly requirements of stepper motors with different dimensions.

Optionally, the second cylindrical body 3 includes second magnets 111 spliced to each other, and the second magnets are formed after the first magnets 1 are processed by the grinding process. Two adjacent second magnets 111 are magnetically opposite at respective ends close to the central axis of the second cylindrical body 3, and the two adjacent second magnets 111 are magnetically opposite at other respective ends.

The plurality of first magnets 1 may include 2 first magnets 1, 3 first magnets 1, 4 first magnets 1, 5 first magnets 1, 6 first magnets 1, 8 first magnets 1 and the like. Correspondingly, the second magnets 111 formed after the grinding process may include 2 second magnets 111, 3 second magnets 111, 4 second magnets 111, 5 second magnets 111, 6 second magnets 111, 8 second magnets 111 and the like.

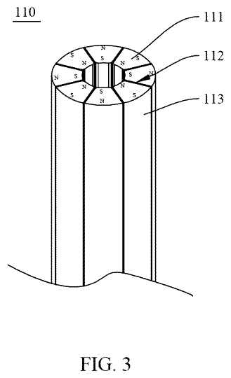

For example, in some embodiments, when the number of the formed second magnets 111 is 8, the 8 second magnets 111 are spliced together to form the second cylindrical body 3. One end of each second magnet 111 away from the center axis of the second cylindrical body 3 and the other end of each second magnet 111 close to the center axis of the second cylindrical body 3 have opposite magnetism. Exemplarily, as shown in FIG. 3, the magnetic pole of one second magnet 111 at the end close to the center axis of the second cylindrical body 3 is an N-pole, and the magnetic pole of this second magnet 111 at the other end away from the center axis of the second cylindrical body 3 is an S-pole. Moreover, for two adjacent second magnets 111, the two second magnets 111 are magnetically opposite at respective ends close to the central axis of the second cylindrical body 3, for example, the magnetic pole of one second magnet 111 is an N-pole at its end close to the central axis of the second cylindrical body 3, while the magnetic pole of the other one second magnet 111 adjacent to this second magnet 111 is an S-pole at its end close to the central axis of the second cylindrical body 3. The two adjacent second magnets 111 are magnetically opposite at other respective ends, for example, the magnetic pole of one second magnet 111 is an S-pole at its end away from the central axis of the second cylindrical body 3, while the magnetic pole of the other one second magnet 111 adjacent to this second magnet 111 is an N-pole at its end away from the central axis of the second cylindrical body 3.

In the step S3, further in the process of processing the first cylindrical body 2 by the grinding process to obtain the second cylindrical body 3, optionally, the specific outer diameter of the first cylindrical body 2 and the outer diameter of the formed second cylindrical body 3 may be specifically set according to actual needs.

For example, in some embodiments of the present disclosure, the deformation amount of the outer diameter of the first cylindrical body 2 may be from 42.8125% to 43.4375%. The outer diameter of the first cylindrical body 2 may be 3.2 mm and the outer diameter of the second cylindrical body 3 may be 1.82±0.01 mm.

Optionally, in the step S3, the grinding process includes one or more of longitudinal grinding, plunge grinding, segmented grinding, or deep grinding.

Optionally, in the step S3, the coating 113 is a Ni metal coating formed by metal Ni electroplating, or a composite metal coating formed from Zn and Ni. The electroplating process is carried out after the grinding process, which guarantees that the outer side of the formed second cylindrical body 3 can be electroplated to form a uniform coating, ensuring the stability of the magnets.

Optionally, the first magnets 1 are sintered magnets. The use of sintered magnets as the first magnets 1 can effectively improve the torque of the product and the performance of the magnetic circuit. In addition, the plurality of the first magnets 1 each can be individually processed into shape in advance and then spliced together, which can make the assembly process simpler, and further satisfy the assembly requirements of motors with different dimensions, which may improve the stability and reliability and be conducive to improving the driving performance of the motors.

Two adjacent first magnets 1 are bonded and fixed to each other by a bonding layer 112. The bonding layer 112 may adopt glue, and the use of the bonding layer 112 to fix two adjacent first magnets 1 can improve the stability of the plurality of first magnets 1 after being spliced.

In a second aspect, the present disclosure provides a multi-pole magnetic circuit 110, which is manufactured by the manufacturing method as described above.

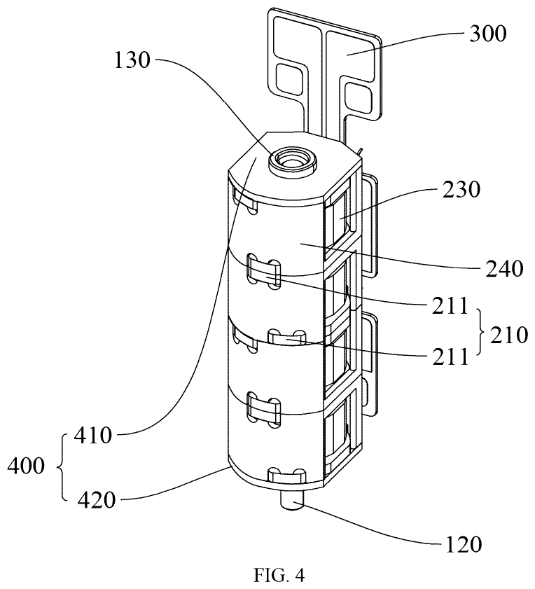

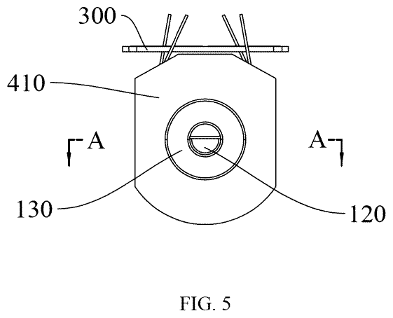

In a third aspect, the present disclosure provides a stepper motor. As shown in FIGS. 4 to 6, the stepper motor includes a rotor assembly 100 and a stator assembly 200 socketed around an outer periphery of the rotor assembly 100. The rotor assembly 100 includes a multi-pole magnetic circuit 110 manufactured by the manufacturing method as described above, or a multi-pole magnetic circuit 110 as described above.

The multi-pole magnetic circuit 110 is overall in the shape of a hollow cylinder including several second magnets 111 spliced together. The rotor assembly 100 further includes a rotary shaft 120 passing through the centerline axis of the multi-pole magnetic circuit 110. That is, the several second magnets 111 are arranged along a circumferential direction of the rotary shaft 120. Two adjacent second magnets 111 are magnetically opposite to each other at respective ends close to the rotary shaft 120 and the two adjacent second magnets 111 are magnetically opposite to each other at other respective ends.

Two adjacent second magnets 111 are bonded and fixed to each other by a bonding layer 112, and the outer surface of the multi-pole magnetic circuit 110 is provided with a coating 113.

In some embodiments, the stepper motor includes a rotor assembly 100 and one stator assembly 200. In some other embodiments, the stepper motor includes a rotor assembly 100 and a plurality of stator assemblies 200 that are sequentially stacked along an axial direction of the rotor assembly 100.

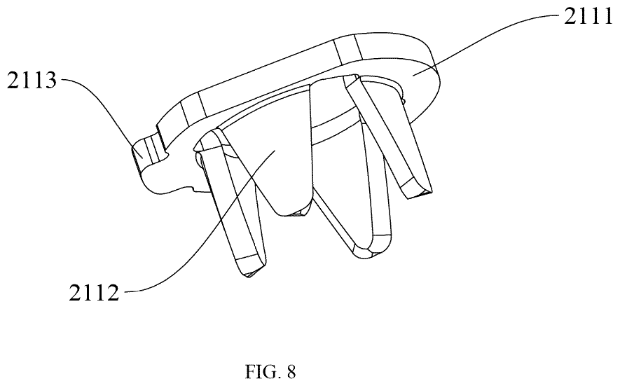

Each of the stator assemblies 200 includes a claw-pole assembly 210, a plastic member 220, a coil 230, and an outer shell 240, which are sequentially socketed outer side of the rotor assembly 100 from inside to outside. The claw-pole assembly 210 includes two claw-poles 211 provided opposite to each other at intervals. As shown in FIG. 8, the claw-pole 211 includes a claw plate 2111, several claw fingers 2112 vertically distributed on the claw plate 2111 along a circumferential direction, and a limiting portion 2113 extending outward from the claw plate 2111. The claw fingers 2112 are tooth-shaped and wider ends of the claw fingers 2112 are connected to the claw plate 2111. The outer shell 240 is provided with a limiting groove for the the limiting portion 2113 to be placed. The number of the claw fingers 2112 is set to 3 or 4, and the claw fingers 2112 are evenly distributed along the circumferential direction of the claw plate 2111.

The rotor assembly 100 further includes a flexible circuit board 300 electrically connected to the coil 230, and the flexible circuit board 300 is provided outside the outer shell 240. The stepper motor further includes end covers 400 provided at both ends of the outer shell 240. Both ends of the rotary shaft 120 pass through the end covers 400, and both ends of the rotary shaft 120 are connected to the end covers 400 by bearings 130, respectively.

The number of the stator assemblies 200 may be any integer from 1 to 4.

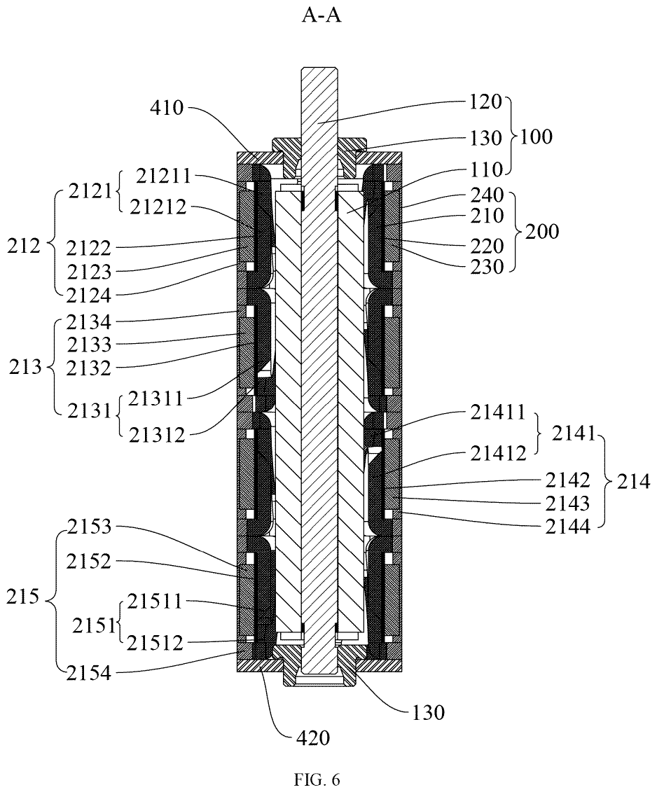

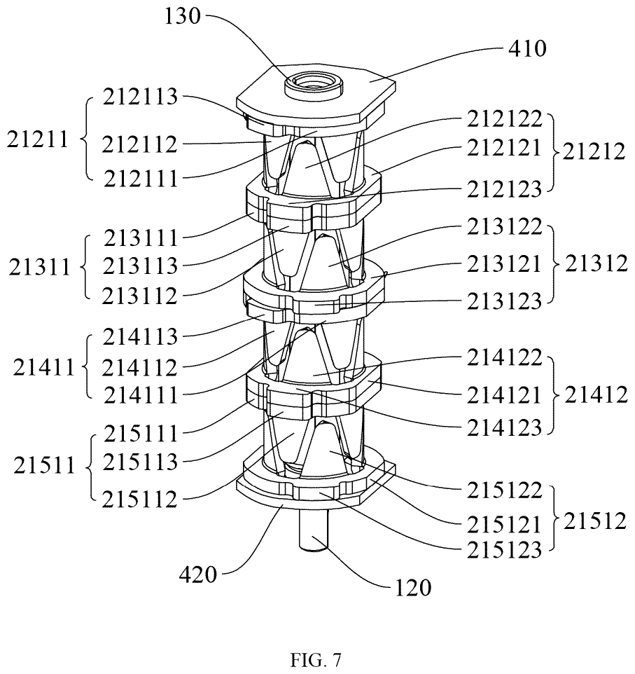

In some embodiments, as shown in FIGS. 6 and 7, when the stepper motor includes one rotor assembly 100, and four stator assemblies 200 sequentially stacked along the axial direction of the rotor assembly 100, the stator assemblies 200 include a first stator assembly 212, a second stator assembly 213, a third stator assembly 214, and a fourth stator assembly 215 sequentially arranged from one end to the other end of the rotor assembly 100. The end covers 400 include a first end cover 410 connected to one end of the rotary shaft 120 and a second end cover 420 connected to the other end of the rotary shaft 120.

The first stator assembly 212 includes a first claw-pole assembly 2121, a first plastic member 2122, a first coil 2123, and a first outer shell 2124 sequentially provided from inside to outside. The first claw-pole assembly 2121 includes a first claw-pole 21211 and a second claw-pole 21212 provided opposite to each other at intervals. The first claw-pole 21211 includes a first claw plate 212111, first claw fingers 212112, and a first limiting portion 212113, and the second claw-pole 21212 includes a second claw plate 212121, second claw fingers 212122, and a second limiting portion 212123. The first claw fingers 212112 are inserted into gaps between the second claw fingers 212122, and an outer wall of the first claw plate 212111 and an outer wall of the second claw plate 212121 are connected to an inner wall of the first outer shell 2124. The first claw plate 212111 is connected to the first end cover 410. The first limiting portion 212113 and the second limiting portion 212123 are arranged in a staggered manner along a direction parallel to the central axis of the rotary shaft 120. The first claw plate 212111, the first claw fingers 212112, the second claw fingers 212122, the second claw plate 212121, and the first outer shell 2124 together enclose to form a first mounting groove, and the first plastic member 2122 and the first coil 2123 are provided within the first mounting groove from from inside to outside.

The second stator assembly 213 includes a second claw-pole assembly 2131, a second plastic member 2132, a second coil 2123, and a second outer shell 2134 sequentially provided from inside to outside. The second claw-pole assembly 2131 includes a third claw-pole 21311 and a fourth claw-pole 21312 provided opposite to each other at intervals. The third claw-pole 21311 includes a third claw plate 213111, third claw fingers 213112, and a third limiting portion 213113, and the fourth claw-pole 21312 includes a fourth claw plate 213121, fourth claw fingers 213122, and a fourth limiting portion 213123. The third claw fingers 213112 are inserted into gaps between the fourth claw fingers 213122, and an outer wall of the third claw plate 213111 and an outer wall of the fourth claw plate 213121 are connected to an inner wall of the second outer shell 2134. The third claw plate 213111 is connected to the first claw plate 212111. The third limiting portion 213113 is connected to the first limiting portion 212113, and the fourth limiting portion 213123 is staggered from the first limiting portion 212113 and the the second limiting portion 212123. The third claw plate 213111, the third claw fingers 213112, the fourth claw fingers 213122, the fourth claw plate 213121, and the second outer shell 2134 together enclose to form a second mounting groove, and the second plastic member 2132 and the second coil 2123 are provided within the second mounting groove from from inside to outside.

The third stator assembly 214 includes a third claw-pole assembly 2141, a third plastic member 2142, a third coil 2143, and a third outer shell 2144 sequentially provided from inside to outside. The third claw-pole assembly 2141 includes a fifth claw-pole 21411 and a sixth claw-pole 21412 provided opposite to each other at intervals. The fifth claw-pole 21411 includes a fifth claw plate 214111, fifth claw fingers 214112, and a fifth limiting portion 214113, and the sixth claw-pole 21412 includes a sixth claw plate 214121, sixth claw fingers 214122, and a sixth limiting portion 214123. The fifth claw fingers 214112 are inserted into gaps between the sixth claw fingers 214122, and an outer wall of the fifth claw plate 214111 and an outer wall of the sixth claw plate 214121 are connected to an inner wall of the third outer shell 2144. The fifth claw plate 214111 is connected to the fourth claw plate 213111. The fifth limiting portion 214113 is aligned with the first limiting portion 212113, and the sixth limiting portion 214123 is aligned with the second limiting portion 212113. The fifth claw plate 214111, the fifth claw fingers 214112, the sixth claw fingers 214122, the sixth claw plate 214121, and the third outer shell 2144 together enclose to form a third mounting groove, and the third plastic member 2142 and the third coil 2143 are provided within the third mounting groove from from inside to outside.

The fourth stator assembly 215 includes a fourth claw-pole assembly 2151, a fourth plastic member 2152, a fourth coil 2153, and a fourth outer shell 2154 sequentially provided from inside to outside. The fourth claw-pole assembly 2151 includes a seventh claw-pole 21511 and an eighth claw-pole 21512 provided opposite to each other at intervals. The seventh claw-pole 21511 includes a seventh claw plate 215111, seventh claw fingers 215112, and a seventh limiting portion 215113, and the eighth claw-pole 21512 includes an eighth claw plate 215121, eighth claw fingers 215122, and a eighth limiting portion 215123. The seventh claw fingers 215112 are inserted into gaps between the eighth claw fingers 215122, and an outer wall of the seventh claw plate 215111 and an outer wall of the eighth claw plate 215121 are connected to an inner wall of the fourth outer shell 2154. The seventh claw plate 215111 is connected to the sixth claw plate 214121, and the eighth claw plate 215121 is connected to the second end cover 420. The seventh limiting portion 215113 is aligned with the sixth limiting portion 214113, and the eighth limiting portion 215123 is aligned with the fourth limiting portion 213113. The seventh claw plate 215111, the seventh claw fingers 215112, the eighth claw fingers 215122, the eighth claw plate 215121, and the fourth outer shell 2154 together enclose to form a fourth mounting groove, and the fourth plastic member 2152 and the fourth coil 2153 are provided within the fourth mounting groove from from inside to outside.

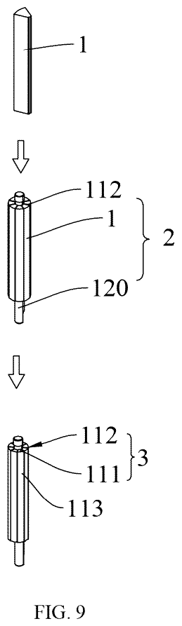

Optionally, in some other embodiments, as shown in FIG. 9, the step S2 further includes providing a rotary shaft 120. The step S2 specifically includes: providing a rotary shaft 120, arranging the obtained plurality of first magnets 1 circumferentially around the rotary shaft 120 to obtain the first cylindrical body 2 with the rotary shaft 120; and obtaining the second cylindrical body 3 with the rotary shaft 120 after performing the grinding process.

Comparative Embodiment 1: compared with Embodiment 1, the outer diameter of the multi-pole magnetic circuit 110 in Comparative Embodiment 1 is the same as the outer diameter of the multi-pole magnetic circuit 110 in Embodiment 1, and the number of magnets spliced is the same, except that the multi-pole magnetic circuit 110 in Comparative Embodiment 1 is directly prepared to obtain third magnets having the same outer diameter as that of the second magnets 111, and then the third magnets are spliced to obtain a third cylindrical body having the same outer diameter as that of the second cylindrical body 3, and then a surface of the third cylindrical body is electroplated to obtain the multi-pole magnetic circuit 110.

Compared to Comparative Embodiment 1, the concentricity of the multi-pole magnetic circuit 110 manufactured by the manufacturing method as described herein is improved from ±5 s to ±1 s, and the roundness and concentricity of the multi-pole magnetic circuit 110 manufactured by the manufacturing method as described herein are better, and the reliability of the magnetic circuit is better.

The above-described is only implementations of the present disclosure, and it should be noted herein that improvements can be made for those of ordinary skill in the art without departing from the inventive conception of the present disclosure, but these all fall within the protection scope of the present disclosure.

What is claimed is:

1. A manufacturing method of a multi-pole magnetic circuit, comprising:
providing a plurality of first magnets, wherein each of the first magnets has a sector-ring-shaped cross-section ;
assembling the plurality of first magnets to obtain a first cylindrical body; and
grinding a side surface of the first cylindrical body by a grinding process to obtain a second cylindrical body, and electroplating an outer surface of the second cylindrical body to form a coating, so as to obtain the multi-pole magnetic circuit for a stepper motor.

2. The manufacturing method as described in claim 1, wherein the first magnets are shaped by the grinding process to form second magnets, the second magnets are arranged around a central axis of the multi-pole magnetic circuit, two adjacent second magnets are magnetically opposite to each other at respective ends close to the central axis of the multi-pole magnetic circuit, and the two adjacent second magnets are magnetically opposite to each other at other respective ends.

3. The manufacturing method as described in claim 1, wherein the grinding process comprises one or more of longitudinal grinding, plunge grinding, segmented grinding, or deep grinding.

4. The manufacturing method as described in claim 1, whereinthe coating is a Ni metal coating formed by metal Ni electroplating, or a composite metal coating formed from Zn and Ni.

5. The manufacturing method as described in claim 1, wherein the first magnets are sintered magnets, and two adjacent first magnets are bonded and fixed to each other by a bonding layer.

6. The manufacturing method as described in claim 1, wherein the assembling the plurality of first magnets to obtain a first cylindrical body comprises:
providing a rotary shaft; and
arranging the plurality of first magnets circumferentially around the rotary shaft to obtain the first cylindrical body with the rotary shaft.

7. A multi-pole magnetic circuit manufactured by the manufacturing method as described in claim 1.

8. A stepper motor, comprising the multi-pole magnetic circuit as described in claim 7.
